(19) United States
(12) Patent Application Publication
(10) Pub. No.: US 2016/0200441 A1
(43) Pub. Date: Jul. 14, 2016

(54) COOLING SYSTEM HAVING A WATER SEPARATOR, AND METHOD FOR OPERATING A COOLING SYSTEM

(71) Applicant: AIRBUS OPERATIONS GMBH, Hamburg (DE)

(72) Inventors: Torsten TRUEMPER, Hamburg (DE); Jannic VOELKER, Hamburg (DE)

(21) Appl. No.: 14/991,402

(22) Filed: Jan. 8, 2016

(30) Foreign Application Priority Data
Jan. 8, 2015 (DE) 10 2015 200 111.3

(51) Int. Cl. B64D 13/06; B60H 1/32; B64D 11/04; F25D 21/14; F25B 41/00; F25B 47/00; F25D 21/12

(52) U.S. Cl. CPC B64D 13/06; F25B 47/006; B60H 1/32; F25D 21/125; F25D 21/14; F25B 41/00; B64D 11/04; B60H 2001/006

(57) ABSTRACT

A cooling system with a heat exchanger, which is designed or configured for through-flow of a coolant and a fluid to be cooled, a fluid line, which is designed or configured for through-flow of fluid emerging from the heat exchanger, and a conveying device, which is designed or configured to convey the fluid through the heat exchanger and the fluid line. A control device is designed or configured to control the conveying device in such a manner that the fluid flows through the heat exchanger and the fluid line in the same direction when the cooling system is in a normal mode and when in a de-icing mode. In addition, there is a water separator disposed in the fluid line.

### CROSS-REFERENCE TO RELATED APPLICATION

This application claims priority to German Patent Application DE 10 2015 200 111.3 filed Jan. 8, 2015, the entire disclosure of which is incorporated by reference herein.

### TECHNICAL FIELD

The disclosure herein relates to a cooling system that is suitable, in particular, for use on board an aircraft, and to a method for operating such a cooling system.

### BACKGROUND

In modern passenger aircrafts, there is usually at least one device to be cooled that is provided in the region of an aircraft on-board kitchen, a so-called galley. The device to be cooled may be, for example, a trolley or a galley region that is used, for example, for storing foodstuffs provided for distribution to the aircraft passengers. A galley device that is to be cooled may be supplied with cooling energy by a decentralized cooling station, for example in the form of an air chiller, or by a cooling station, described in DE 43 40 317 C2 and U.S. Pat. No. 5,513,500 or EP 1 979 233 A1 and US 2009/000329 A1, which, for its part, is supplied with cooling energy by a central refrigerating device of the aircraft.

Irrespective of whether a cooling station is a decentralized device or is connected to a central refrigerating device, the cooling station usually comprises a heat exchanger, through which there flow a coolant and ambient air to be cooled. After flowing through the heat exchanger, the then cool ambient air is supplied to the device to be cooled, normally in an upper region of the device to be cooled. Owing to the cooling-down of the ambient air as it flows through the heat exchanger, water contained in the stream of ambient air condenses out in the heat exchanger and settles, in the form of an ice layer, on cold heat-exchanger surfaces, the temperatures of which may be as low as −9° C. The cooling capacity of the cooling station is impaired, however, if the cross-section of the heat exchanger through which flow can be effected is reduced as a result of the deposition of ice layers.

When the cooling station is in operation, therefore, regular de-icing cycles are provided, in which the direction of flow of the ambient air through the heat exchanger, which, when the cooling station is in normal mode, is directed contrary to gravity, i.e. from bottom to top, is reversed by reversal of a direction of rotation of conveying device in the form of a fan. During the de-icing cycle, the ambient air then flowing through the heat exchanger from top to bottom, i.e. in the direction of gravity, is thus used to thaw ice deposited on cold surfaces of the heat exchanger, and to blow it out of the heat exchanger. The water removed from the heat exchanger is collected in a collecting container, which is provided in a region of the heat exchanger that is near the floor.

### SUMMARY

The disclosure herein is based on an object of providing a cooling system that is suitable, in particular, for use on board an aircraft, and that can be de-iced in an efficient and simple manner, and that therefore can be operated overall in an efficient manner and with a high cooling capacity. The disclosure herein is additionally directed towards the object of specifying a method for operating such a cooling system.

These objects are achieved by a cooling system and method for operating a cooling system disclosed herein.

A cooling system comprises a heat exchanger, which is designed or configured for through-flow of a coolant and a fluid to be cooled. The coolant may be a two-phase coolant, i.e. a coolant that, when cooling energy is given off to the fluid to be cooled, is transformed from the liquid to the gaseous state. As an alternative to this, however, the cooling system may also be operated with a single-phase coolant. The fluid to be cooled is, in particular, ambient air. The cooling system additionally comprises a fluid line, which is designed or configured for through-flow of fluid emerging from the heat exchanger. The fluid line is preferably disposed downstream from the heat exchanger, with regard to the direction of flow of the fluid through the cooling system, i.e. is connected to a fluid outlet of the heat exchanger. The fluid line serves, in particular, to supply the fluid, emerging from the heat exchanger and cooled to a low temperature as it flows through the heat exchanger, to a device to be cooled, for example to an aircraft-galley device to be cooled.

The cooling system additionally comprises a conveying device, which is designed or configured to convey the fluid through the heat exchanger and the fluid line. In particular, if the fluid to be conveyed through the heat exchanger and the fluid line is ambient air, the conveying device is preferably in the form of a fan. A control device of the cooling system is designed or configured to control the conveying device in such a manner that the fluid flows through the heat exchanger and the fluid line in the same direction when the cooling system is in a normal mode and when in a de-icing mode. Consequently, in the case of the cooling system, in a transition from a normal mode of the cooling system, in which the cooling system provides fluid, cooled to a desired low temperature as it flows through the heat exchanger, to a device to be cooled, and from a de-icing mode, in which ice layers that have settled on cold heat-exchanger surfaces in the heat exchanger are removed from the heat exchanger, no reversal of the direction of flow of the fluid through the heat exchanger and the fluid line occurs.

A reversal of a drive direction of the conveying device, i.e. in particular a reversal of the direction of rotation of a conveying device, in the form of a fan, in the transition from the normal mode to the de-icing mode of the cooling system, is therefore no longer necessary. Noise loads, which can impair the comfort of passengers seated close to the cooling system, can thereby be avoided. Moreover, the full conveying power of the conveying device is also available during the de-icing mode of the cooling system, since conveying-line losses, which are usually unavoidable in the case of a reversal of the drive direction of the conveying line, do not occur. The de-icing cycles can thus be kept shorter than is possible in the de-icing mode of the cooling system with a reversal of the drive direction of the conveying device. Consequently, the periods of time in which the cooling system does not provide any cooling energy to the device to be cooled can be shortened. This results in an overall greater cooling capacity of the cooling system.

Finally, the cooling system comprises a water separator disposed in the fluid line. Drops of water, contained in the fluid stream flowing through the fluid line, can be separated out of the fluid stream by the water separator. The water separator thus prevents water, removed from the heat exchanger when the cooling system is in the de-icing mode, from settling at an unsuitable point in the fluid line, or being supplied to the device to be cooled. However, since the fluid stream that flows through the fluid line passes through the water separator, not only when the cooling system is in the de-icing mode, but also when in the normal mode, the water separator should be designed or configured such that it causes only a slight drop in pressure in the fluid stream flowing through the fluid line.

In a preferred embodiment of the cooling system, the control device is designed or configured to control the conveying device in such a manner that the fluid flows through the fluid line in the direction of gravity, i.e. from top to bottom, when the cooling system is in the normal mode and when in the de-icing mode. This enables gravity to be utilized in the water separator to separate drops of water, emerging from the heat exchanger when the cooling system is in the de-icing mode, out of the fluid stream flowing through the fluid line.

The fluid line may comprise a fluid outlet opening for removing the fluid from the fluid line. In particular, the fluid outlet opening may be disposed in a downstream end region of the fluid line, i.e. in an end region of the fluid line that faces away from the fluid outlet of the heat exchanger. For example, the fluid outlet opening may be disposed in a first side wall of the fluid line. The fluid flowing through the fluid line can be supplied, through the fluid outlet opening, to the device to be cooled. If the cooling system is disposed, relative to the device to be cooled, in such a manner that the fluid outlet opening opens into a lower region of the device to be cooled, the fluid emerging from the fluid outlet opening flows from bottom to top through the device to be cooled.

The water separator may comprise a water separating grating, disposed in the fluid line and extending over at least a portion of a cross-section of the fluid line through which flow can be effected. The water separating grating may be provided with a plurality of openings, the number and size of which are selected such that drops of water contained in the fluid stream flowing through the fluid line are able to pass through the water separating grating, but a gaseous component of the fluid stream flowing through the fluid line is deflected, at least partially, at the water separating grating. The openings provided in the water separating grating may be, for example, circular in form and have a diameter of approximately 3 mm. Moreover, the openings should be disposed at such a distance from each other that only a small portion of the gaseous component of the fluid stream flowing through the fluid line passes through the openings provided in the water separating grating, but the greater portion of the gaseous component of the fluid stream flowing through the fluid line is deflected at the water separating grating.

The water separating grating serves to reliably separate drops of water, contained in the fluid stream flowing through the fluid line, from the gaseous component of the fluid stream flowing through the fluid line. At the same time, the drop in pressure, caused by the water separating grating, in the fluid stream flowing through the fluid line is relatively small. Consequently, the additional conveying capacity to be provided by the conveying device, when the cooling system is in the normal mode and when in the de-icing mode, for compensating this drop in pressure can also be kept comparatively small, this having a positive effect on the energy consumption of the conveying device and on the noise load generated by the conveying device.

Preferably, the water separating grating is disposed in the fluid line such that the gaseous component of the fluid stream flowing through the fluid line is deflected at the water separating grating, at least partially, in the direction of the fluid outlet opening for removing the fluid from the fluid line. The water separating grating then performs the dual function, on the one hand, of separating drops of water, contained in the fluid stream flowing through the fluid line, out of the fluid line, and at the same time deflecting the gaseous component of the fluid stream flowing through the fluid line in the direction of the fluid outlet opening for removing the fluid from the fluid line.

For example, the water separating grating may be disposed in the fluid line such that it is aligned at an angle of approximately 30 to 60°, in particular at an angle of approximately 40 to 50°, and particularly preferably at an angle of approximately 45°, in relation to the direction of flow of the fluid stream flowing through the fluid line. The water separating grating is then particularly suited, on the one hand, to separating out drops of water from the fluid stream flowing through the fluid line and, on the other hand, to deflecting the gaseous component of the fluid stream flowing through the fluid line in the direction of a fluid outlet opening disposed in a first side wall of the fluid line.

The water separating grating may have a curved contour and extend, in particular in a concavely curved manner, from a second side wall of the fluid line that is opposite the first side wall of the fluid line, in the direction of the first side wall of the fluid line, and consequently in the direction of the fluid outlet opening provided in the first side wall. A water separating grating having a curved contour provides for an effective, but at the same time also comparatively low-turbulence, deflection of the gaseous component of the fluid stream flowing through the fluid line in the direction of the fluid outlet opening in the first side wall of the fluid line. The drop in pressure in the fluid stream flowing through the fluid line that is produced by the water separating grating when the cooling system is in the normal mode can thus be further reduced.

The water separator of the cooling system may further comprise a flow deflecting device, which is designed or configured to deflect the fluid stream, flowing through the fluid line, in the direction of a surface of the water separating grating. Through the provision of a flow deflecting device, it can be ensured, even in the case of unfavorable geometries of the fluid line, that the water separating grating of the water separator exhibits the desired water-separating and flow-deflecting properties. Moreover, by deflection of the fluid stream flowing through the fluid line in the direction of a surface of the water separating grating, it can be ensured that even small drops of water are separated out of the fluid stream flowing through the fluid line by the water separating grating.

The flow deflecting device may comprise, for example, a flow deflecting element, which extends from the first side wall of the fluid line in the direction of the surface of the water separating grating. The flow deflecting element may be fastened, by a fastening element, to an inner face of the first side wall of the fluid line, and extend at an angle of approximately 30 to 60°, in particular at an angle of approximately 40 to 50°, and particularly preferably at an angle of 45°, in relation to the direction of flow of the fluid stream flowing through the fluid line, in the direction of an interior of the fluid line, i.e. into the fluid stream flowing through the fluid line. By the flow deflecting element, therefore, the fluid stream flowing through the fluid line is first routed onto the surface of the water separating grating, before the gaseous component of the fluid stream flowing through the fluid line is again deflected at the surface of the water separating grating and finally deflected out of the fluid line via the fluid outlet opening.

The water separator of the cooling system may additionally comprise a catching device for catching drops of water settled on an inner face of the fluid line. By the catching device, drops of water, which run along on the inner face of the fluid line, by the action of gravity, can be caught and removed from the fluid stream flowing through the fluid line.

The catching device may comprise, for example, a catching element, which extends, along an inner circumference of the fluid line, from the inner circumference of the fluid line in the direction of an interior of the fluid line. The catching element can directly remove the drops of water, collected therein, from the fluid line. Preferably, however, drops of water caught by the catching element are routed through the water separating grating of the water separator and ultimately subjected to further processing, together with the drops of water separated by the water separating grating out of the fluid stream flowing through the fluid line, as explained in the following. For this purpose, the catching element is preferably disposed in the fluid line in such a manner that drops of water caught by the catching element flow, by the action of gravity, in the direction of the water separating grating.

In particular, the catching element may be inclined, about an axis extending in the direction of the fluid flow through the fluid line, in the direction of the water separating grating, and additionally about an axis extending perpendicularly in relation to the direction of the fluid flow through the fluid line. This arrangement of the catching element in the fluid line ensures that it is possible for drops of water to be removed from all portions of the catching element, in the direction of the water separating grating, by the action of gravity.

The water separator may additionally comprise a collecting device for collecting drops of water separated out from the fluid stream flowing through the fluid line. This collecting device is preferably disposed in a downstream end region of the fluid line. If flow is effected in the direction of gravity through the fluid line, when the cooling system is in the de-icing mode, drops of water flowing, by the action of gravity, in the direction of the collecting device can thus be collected in the collecting device and, if required, can ultimately be deflected out of the cooling system.

In the case of a method for operating a cooling system, a coolant and a fluid to be cooled are routed through a heat exchanger. Fluid emerging from the heat exchanger is routed through a fluid line. The fluid is conveyed, by a conveying device, through the heat exchanger and the fluid line. The conveying device is controlled in such a manner that the fluid flows through the heat exchanger and the fluid line in the same direction when the cooling system is in a normal mode and when in a de-icing mode. Water drops contained in the fluid stream flowing through the fluid line are separated out of the fluid stream by a water separator disposed in the fluid line.

Preferably, the conveying device is controlled in such a manner that the fluid flows through the fluid line in the direction of gravity, i.e. from top to bottom, when the cooling system is in the normal mode and when in the de-icing mode.

Moreover, the method for operating a cooling system may comprise features described above in connection with the cooling system. In particular, the fluid flowing through the fluid line may be removed from the fluid line through a fluid outlet opening, which is disposed, in particular, in a downstream end region of the fluid line, preferably in a first side wall of the fluid line.

Moreover, water drops contained in the fluid stream flowing through the fluid line may be separated out of the fluid stream by a water separator, which comprises a water separating grating that is disposed in the fluid line and extends, at least, over a portion of a cross-section of the fluid line through which flow can be effected. A plurality of openings may be provided in the water separating grating, the number and size of which are selected such that drops of water contained in the fluid stream flowing through the fluid line are able to pass through the water separating grating, but a gaseous component of the fluid stream flowing through the fluid line is deflected, at least partially, at the water separating grating.

The gaseous component of the fluid stream flowing through the fluid line may be deflected at the water separating grating, at least partially, in the direction of the fluid outlet opening for removing the fluid from the fluid line.

Moreover, the fluid stream flowing through the fluid line may be directed, by a flow deflector of the water separator, in the direction of a surface of the water separating grating.

Drops of water settled on an inner face of the fluid line may be caught by a catching element of the water separator. In particular, drops of water caught by a catching element of the catching device may be directed, by the action of gravity, in the direction of the water separating grating.

Finally, drops of water separated out of the fluid stream flowing through the fluid line can be collected in a collecting device of the water separator, which may be disposed, in particular, in a downstream end region of the fluid line.

A cooling system described above and a method described above for operating a cooling system are suitable, in particular, for use on board an aircraft. For example, the cooling system may be used to provide cooling energy to a device to be cooled, for example, in the form of a trolley, or a galley region to be cooled, provided in the region of a galley of the aircraft.

### BRIEF DESCRIPTION OF THE DRAWINGS

A preferred embodiment of the disclosure herein is now explained in greater detail on the basis of the appended schematic drawings, of which

FIG. 1 shows a schematic sectional view of a cooling system,

FIG. 2 shows a three-dimensional sectional view of a fluid line of the cooling system according to FIG. 1, and

FIG. 3 shows a cut-away, three-dimensional rear view of the fluid line according to FIG. 2.

### DETAILED DESCRIPTION

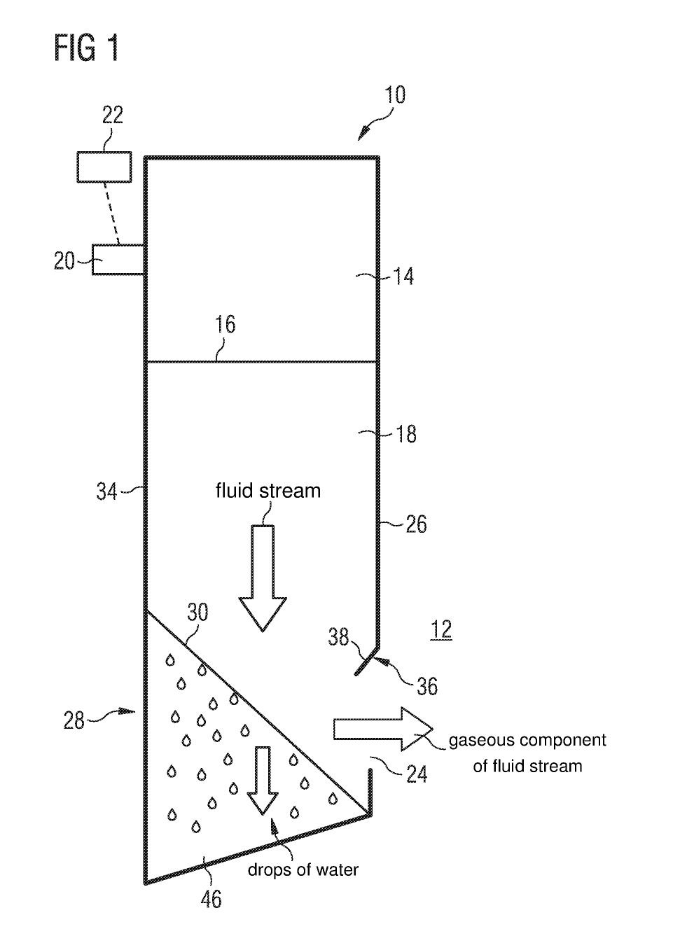

Shown in FIG. 1 is a cooling system 10, which can be used on board an aircraft to supply cooling energy to a device to be cooled, which in this case is a galley region 12 to be cooled. The cooling system 10 comprises a heat exchanger 14, through which there flow a coolant and a fluid to be cooled. In the embodiment shown in FIG. 1, ambient air is routed, as the fluid to be cooled, through the heat exchanger 14. As it flows through the heat exchanger 14, the fluid to be cooled is cooled down to a desired low temperature by giving off thermal energy to the coolant, which is likewise routed through the heat exchanger 14.

A fluid outlet 16 of the heat exchanger 14, through which fluid, cooled down to the desired low temperature, leaves the heat exchanger 14, opens into a fluid line 18. A conveying device 20, in the form of a fan, serves to convey the fluid, firstly through the heat exchanger 14 and then through the fluid line 18. The operation of the conveying device 20 is controlled by a control device 22.

When the cooling system 10 is in the normal mode, comparatively warm ambient air is routed into the heat exchanger 14 and, in flowing through the heat exchanger 14, is cooled down to a low temperature, water contained in the ambient air condenses out in the heat exchanger 14 and settles, in the form of an ice layer, on cold heat-exchanger surfaces. In order to counter an impairment of the cooling capacity of the cooling system 10 caused by the deposition of ice layers, and the resultant reduction in the cross-section of the heat exchanger 14 through which flow can be effected, the cooling system 10 is regularly operated in a de-icing mode. When the cooling system 10 is in the de-icing mode, the supply of coolant to the heat exchanger 14 is prevented, but ambient air continues to be routed through the heat exchanger 14. The stream of warm ambient air conveyed through the heat exchanger 14 by the conveying device 22 when the cooling system 10 is in the de-icing mode consequently serves to thaw ice deposited in the heat exchanger 14, and to blow it out of the heat exchanger 14.

A control device 22 controls the operation of the conveying device 20 in such a manner that the fluid, i.e. the ambient air, flows through the heat exchanger 14 and the fluid line 18 in the same direction when the cooling system 10 is in the normal mode and when in the de-icing mode, respectively. In other words, upon transition from the normal mode to the de-icing mode of the cooling system 10, there is no reversal of the direction of flow of the stream of ambient air through the heat exchanger 14. Instead, the control device 22 controls the conveying device 20 in such a manner that the ambient air flows through the fluid line 18 in the direction of gravity, i.e. from top to bottom in FIG. 1, when the cooling system 10 is in the normal mode and when in the de-icing mode, respectively. After flowing through the fluid line 18, the ambient air, both when the cooling system 10 is in the normal mode and when in the de-icing mode, is removed from the fluid line 18 through a fluid outlet opening 24, which is disposed in a downstream end region of the fluid line 18, in a first side wall 26 of the fluid line 18, and is routed into the galley region 12 to be cooled.

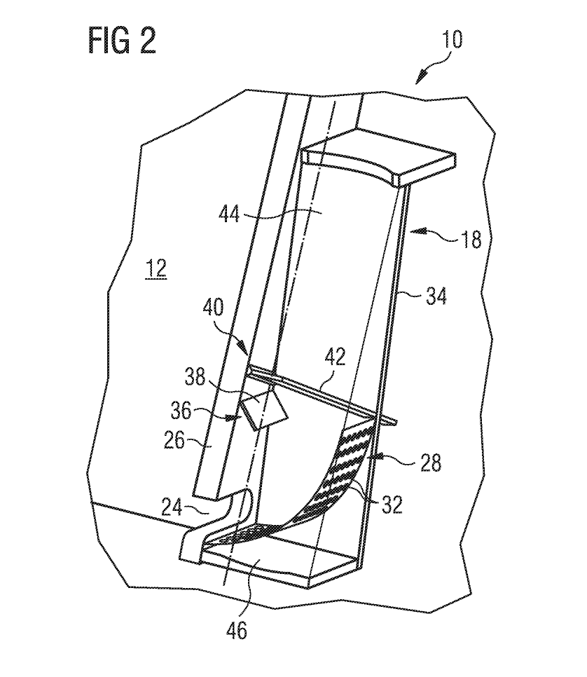

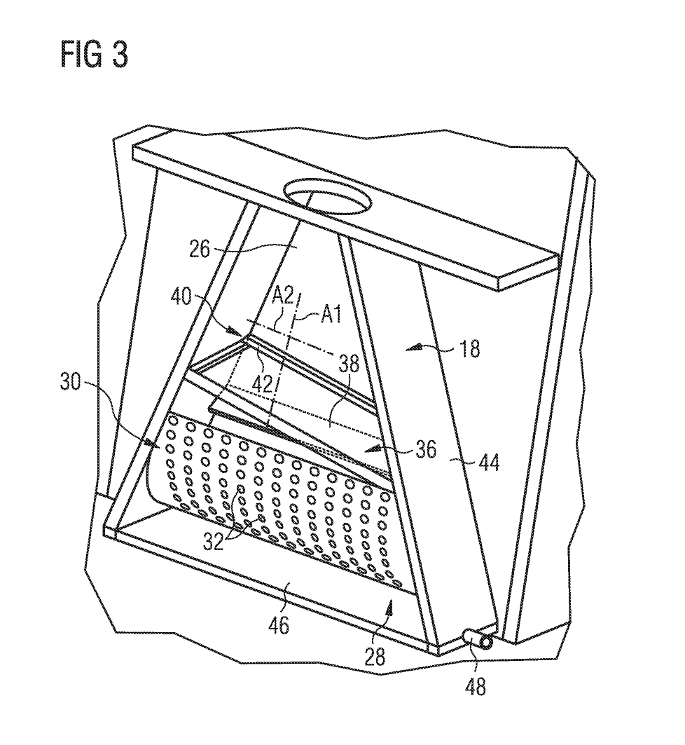

When the cooling system 10 is in the de-icing mode, the stream of ambient air flowing through the fluid line 18 is loaded with drops of water. In order to separate these drops of water out of the stream of ambient air, i.e. to separate them from a gaseous component of the stream of ambient air, a water separator 28, which is represented in greater detail in FIGS. 2 and 3, is disposed in the fluid line 18 of the cooling system 10. The water separator 28 comprises a water separating grating 30, which is provided with a plurality of openings 32. The number and size of the openings 32 are selected such that drops of water contained in the stream of ambient air flowing through the fluid line 18 pass through the openings 32 contained in the water separating grating 30, and can thereby be separated from a gaseous component of the stream of ambient air flowing through the fluid line 18, but the gaseous component of the fluid stream flowing through the fluid line 18 is deflected, at least partially, preferably for the most part, at the water separating grating 30. The openings 32 in the water separating grating 30 may have, for example, a circular cross-section and a diameter of approximately 3 mm.

In particular, the water separating grating 30 is disposed in the fluid line 18 such that it deflects the gaseous component of the stream of ambient air flowing through the fluid line 18, at least partially, in the direction of the fluid outlet opening 24 provided in the first side wall 26 of the fluid line 18. In principle, the water separating grating 30, as illustrated in FIG. 1, may be aligned at an angle of approximately 45° in relation to the direction of flow of the stream of ambient air flowing through the fluid line 18. If, however, as shown in FIGS. 2 and 3, the water separating grating 30 has a curved contour, the angle that the water separating grating 30 forms with the direction of flow of the stream of ambient air flowing through the fluid line 18 varies over the water separating grating 30, in the direction of the fluid flow through the fluid line 18.

In the embodiment of a cooling system 10 shown in the figures, the water separating grating 30 extends in a concavely curved manner from a second side wall 34 of the fluid line 18, which is opposite the first side wall 26 of the fluid line 18, in the direction of the first side wall 26 of the fluid line 18. The water separating grating 30 is thus able to deflect the gaseous component of the stream of ambient air flowing through the fluid line 18 with very low turbulence in the direction of the fluid outlet opening 24 and, at the same time, to provide efficient separation of the water drops, contained in the stream of ambient air, out of the stream of ambient air.

The water separator 28 additionally comprises a flow deflecting device 36, which serves to deflect the stream of ambient air flowing through the fluid line 18 in the direction of a surface of the water separating grating 30. The flow deflecting device 36 comprises a flow deflecting element 38 that is fastened, by a fastening element 40, to an inner face of the first side wall 26 of the fluid line 18 in such a manner that it extends, at an angle of approximately 45° in relation to the direction of flow of the stream of ambient air flowing through the fluid line 18, from the first side wall 26 of the fluid line 18 in the direction of the surface of the water separating grating 30. Owing to the deflection of the stream of ambient air, flowing through the fluid line 18 in the direction of the surface of the water separating grating 30, the flow deflecting device 36 ensures that even small drops of water can be separated out of the stream of ambient air flowing through the fluid line 18.

The water separator 28 additionally comprises a catching element 40, which serves to catch drops of water that settle on the inner face of the fluid line 18 and flow down, by the action of gravity, on the inner face of the fluid line 18. The catching device 40 comprises a catching element 42 that, as shown, in particular, in FIG. 3, extends along the inner circumference of the fluid line 18, from the inner circumference of the fluid line 18 in the direction of an interior of the fluid line 18. The catching element 42 is inclined, both about an axis A1 extending in the direction of the stream of ambient air through the fluid line 18, in the direction of the water separating grating 30, and about an axis A2 extending perpendicularly in relation to the direction of the stream of ambient air through the fluid line 18, in the direction of third side wall 44 of the fluid line 18 that connects the first side wall 26 to the second side wall 34 of the fluid line 18. This arrangement of the catching element 42 in the fluid line 18 ensures that drops of water caught by all portions of the catching element 42 covering the entire inner circumference of the fluid line 18 flow, by the action of gravity, in the direction of the water separating grating 30.

Finally, the water separator 28 comprises a collecting device 46, for collecting drops of water separated out from the stream of ambient air flowing through the fluid line 18. The collecting device 46 is disposed in a downstream end region of the fluid line 18, whereby it is ensured that the drops of water can flow from the water separating grating 30, by the action of gravity, into the collecting device 46. Water collected in the collecting device 46 can be diverted out of the collecting device 46 via a water outlet 48.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A cooling system, comprising:
a heat exchanger for through-flow of a coolant and a fluid to be cooled;
a fluid line for through-flow of fluid emerging from the heat exchanger;
a conveying device to convey the fluid through the heat exchanger and the fluid line;
a control device to control the conveying device such that the fluid flows through the heat exchanger and the fluid line in the same direction when the cooling system is in a normal mode and when in a de-icing mode; and
a water separator disposed in the fluid line.

2. The cooling system according to claim 1, wherein the control device is configured to control the conveying device such that the fluid flows through the fluid line in the direction of gravity when the cooling system is in the normal mode and when in the de-icing mode.

3. The cooling system according to claim 1, wherein the fluid line comprises a fluid outlet opening for removing the fluid from the fluid line.

4. The cooling system according to claim 3, wherein the fluid outlet opening is disposed in a downstream end region of the fluid line.

5. The cooling system according to claim 3, wherein the fluid outlet opening is disposed in a first side wall of the fluid line.

6. The cooling system according to claim 1, wherein the water separator comprises a water separating grating, disposed in the fluid line and extending over at least a portion of a cross-section of the fluid line through which flow can be effected, the water separating grating comprising a plurality of openings, the number and size of which are selected such that drops of water contained in the fluid stream flowing through the fluid line are able to pass through the water separating grating, but a gaseous component of the fluid stream flowing through the fluid line is deflected, at least partially, at the water separating grating.

7. The cooling system according to claim 6, wherein the water separating grating is disposed in the fluid line such that the gaseous component of the fluid stream flowing through the fluid line is deflected at the water separating grating, at least partially, in the direction of the fluid outlet opening for removing the fluid from the fluid line.

8. The cooling system according to claim 6, wherein the water separating grating is disposed in the fluid line such that it is aligned at an angle of approximately 30 to 60°, in particular at an angle of approximately 40 to 50°, and particularly preferably at an angle of approximately 45°, in relation to the direction of flow of the fluid stream flowing through the fluid line.

9. The cooling system according to claim 6, wherein the water separating grating comprises a curved contour and extending, in a concavely curved manner, from a second side wall of the fluid line that is opposite the first side wall of the fluid line, in the direction of the first side wall of the fluid line.

10. The cooling system according to claim 6, wherein the water separator comprises a flow deflecting device, which is configured to deflect the fluid stream, flowing through the fluid line, in the direction of a surface of the water separating grating.

11. The cooling system according to claim 10, wherein the flow deflecting device comprises a flow deflecting element, which extends from the first side wall of the fluid line in the direction of the surface of the water separating grating.

12. The cooling system according to claim 1, wherein the water separator comprises a catching device for catching drops of water settled on an inner face of the fluid line.

13. The cooling system according to claim 12, wherein the catching device comprises a catching element, which extends, along an inner circumference of the fluid line, from the inner circumference of the fluid line in the direction of an interior of the fluid line.

14. The cooling system according to claim 13, wherein the catching element is disposed in the fluid line such that drops of water caught by the catching element flow, by the action of gravity, in the direction of the water separating grating.

15. The cooling system according to claim 13, wherein the catching element is inclined, about an axis extending in the direction of the fluid flow through the fluid line, in the direction of the water separating grating, and additionally about an axis extending perpendicularly in relation to the direction of the fluid flow through the fluid line.

16. The cooling system according to claim 1, wherein the water separator comprises a collecting device, for collecting drops of water separated out from the fluid stream flowing through the fluid line, which is disposed in a downstream end region of the fluid line.

17. A method for operating a cooling system, comprising:
routing a coolant and a fluid to be cooled through a heat exchanger;
routing fluid, emerging from the heat exchanger, through a fluid line;
conveying the fluid through the heat exchanger and the fluid line by a conveying device;
controlling the conveying device such that the fluid flows through the heat exchanger and the fluid line in the same direction when the cooling system is in a normal mode and when in a de-icing mode; and
separating drops of water, contained in the fluid stream flowing through the fluid line, out of the fluid stream by a water separator disposed in the fluid line.

18. The method according to claim 17, wherein the conveying device is controlled such that the fluid flows through the fluid line in the direction of gravity when the cooling system is in the normal mode and when in the de-icing mode.
